(19) United States
(12) Patent Application Publication
(10) Pub. No.: US 2017/0278027 A1
(43) Pub. Date: Sep. 28, 2017

(54) METHOD, APPARATUS, AND SYSTEM FOR GENERATING BUSINESS MODEL, AND COMPUTER READABLE STORAGE MEDIUM

(71) Applicant: Shenzhen Development Promotion Centre for Enterprises, Shenzhen Guangdong (CN)

(72) Inventors: Wei WEI, SHENZHEN GUANGDONG (CN); Wuxiang ZHU, SHENZHEN GUANGDONG (CN)

(73) Assignee: Shenzhen Development Promotion Centre for Enterprises, SHENZHEN GUANGDONG (CN)

(21) Appl. No.: 15/082,433

(22) Filed: Mar. 28, 2016

(51) Int. Cl. G06Q 10/06

(52) U.S. Cl. CPC G06Q 10/067; G06Q 10/063

(57) ABSTRACT

A method, an apparatus, and a system for generating a business model, and a computer readable storage medium are disclosed. The method for generating a business mode includes: obtaining, according to user-configured information about an industry to which an enterprise under analysis belongs, stakeholder information corresponding to the enterprise under analysis, to determine a transaction structure of a business model; obtaining, according to the stakeholder information and a user-configured charge parameter, charge source information of the enterprise under analysis; and generating charge mode data of the business model according to the charge object information and user-configured charge mode information and charge amount information, thereby generating a new business model. In the new business model, a supplier stakeholder and a buyer stakeholder are respectively a supplier and a buyer, a platform provides a venue for the supplier and the buyer to directly perform matching of supply and demand, and both the supplier and the buyer can obtain a large amount of supply information and demand information through the platform, thereby solving a problem that information asymmetry of the supplier and the buyer causes an imbalance of interests between the two parties and hinders matching of supply and demand of the supplier and the buyer.

### TECHNICAL FIELD

The present invention relates to the field of data analyzing and processing, and in particular, to a method, an apparatus, and a system for generating a business model, and a computer readable storage medium.

### BACKGROUND

Market economies have developed for several hundreds of years under circumstances of information asymmetry. As the time goes by, people are increasingly aware of severity of information asymmetry.

On the one hand, information asymmetry may cause an imbalance of interests between a supplier and a buyer, violate social principles of fairness and justice, affect resource configuration efficiency of a market, and cause one party having information advantages to obtain excessive surplus in a transaction, resulting in a severe imbalance of an interest distribution structure due to a great inequality of information power. On the other hand, information asymmetry makes the supplier or the buyer unable to effectively and accurately obtain information of the other party, and hinders matching of supply and demand of the supplier and the buyer.

### SUMMARY

An embodiment of the present invention provides a method for generating a business model, in order to solve a problem that information asymmetry of a supplier and a buyer causes an imbalance of interests between the two parties and hinders matching of supply and demand of the supplier and the buyer in the prior art.

A method for generating a business model according to an embodiment of the present invention includes the following steps:

Obtaining stakeholder information corresponding to the enterprise under analysis according to user-configured information about an industry to which an enterprise under analysis belongs, to determine a transaction structure of a business model;

Obtaining charge source information of the enterprise under analysis according to the stakeholder information and a user-configured charge parameter; and

generating charge mode data of the business model according to the charge object information and user-configured charge mode information and charge amount information; where

the stakeholder information includes at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

An apparatus for generating a business model according to an embodiment of the present invention includes:

a stakeholder information obtaining unit, configured to obtain stakeholder information corresponding to the enterprise under analysis according to user-configured information about an industry to which an enterprise under analysis belongs, to determine a transaction structure of a business model;

a charge source information obtaining unit, configured to obtaining charge source information of the enterprise under analysis according to the stakeholder information and a user-configured charge parameter; and

a charge mode data generation unit, configured to generate charge mode data of the business model according to the charge object information and user-configured charge mode information and charge amount information; wherein

the stakeholder information includes at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

A system for generating a business model includes:

a bus, configured to transmit signaling and data;

a user interface adapter, configured to connect an input device to the bus, and receive information about an industry to which an enterprise under analysis belongs, a charge parameter, charge mode information, and charge amount information that are configured by a user;

a display adapter, configured to connect a display device to the bus, and display the information about the industry to which the enterprise under analysis belongs, the charge parameter, the charge mode information, the charge amount information, obtained charge source information, and generated charge mode data; and

a business model generation apparatus, configured to receive the information about the industry to which the enterprise under analysis belongs, the charge parameter, the charge mode information, and the charge amount information that are transmitted by the user interface adapter through the bus, and obtain, according to the information about the industry to which the enterprise under analysis belongs, stakeholder information corresponding to the enterprise under analysis, to determine a transaction structure of a business model; obtain the charge source information of the enterprise under analysis according to the stakeholder information and the user-configured charge parameter; and generate the charge mode data of the business model according to the charge object information and the user-configured charge mode information and charge amount information; where

the stakeholder information includes at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

A computer readable storage medium is provided, wherein the computer readable storage medium stores a computer program instruction executable by a computer, and when the computer executes the computer program instruction, the computer executes a method for generating a business model, wherein the method for generating a business model includes:

obtaining stakeholder information corresponding to the enterprise under analysis according to user-configured information about an industry to which an enterprise under analysis belongs, to determine a transaction structure of a business model;

obtaining charge source information of the enterprise under analysis according to the stakeholder information and a user-configured charge parameter; and

generating charge mode data of the business model according to the charge object information and user-configured charge mode information and charge amount information; wherein

the stakeholder information includes at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand may be performed by using a platform provided by the enterprise under analysis.

In the method for generating a business model according to the embodiment of the present invention, stakeholder information corresponding to an enterprise under analysis is obtained according to information about an industry to which the enterprise under analysis belongs, so that a transaction structure of a business model is determined; further, charge source information of the enterprise under analysis is obtained according to the stakeholder information and a user-configured charge parameter; and charge mode data of the business model is generated according to the charge object information and user-configured charge mode information and charge amount information, so that a new business model is generated. In the new business model, a platform provided by the enterprise under analysis provides a venue for a supplier stakeholder and a buyer stakeholder to perform matching of supply and demand, and both the supplier stakeholder and the buyer stakeholder can obtain a large amount of supply information and demand information through the platform, thereby solving a problem that information asymmetry causes an imbalance of interests between the two parties and hinders matching of supply and demand of the supplier and the buyer.

### BRIEF DESCRIPTION OF DRAWINGS

FIG. 1 is a flowchart of a method for generating a business model according to an embodiment of the present invention;

FIG. 2 is a schematic diagram of a structure of a new business model generated according to an embodiment of the present invention;

FIG. 3 is a flowchart of another method for generating a business model according to an embodiment of the present invention;

FIG. 4 is a schematic diagram of a structure of an apparatus for generating a business model according to an embodiment of the present invention;

FIG. 5 is a schematic diagram of a structure of another apparatus for generating a business model according to an embodiment of the present invention; and

FIG. 6 is a schematic diagram of a structure of a system for generating a business model according to an embodiment of the present invention.

### DESCRIPTION OF EMBODIMENTS

To make the objectives, technical solutions, and advantages of the present invention more comprehensible, the following describes the present invention in detail with reference to embodiments and accompanying drawings. It should be understood that the specific embodiments described herein are merely used to explain the present invention but are not intended to limit the present invention.

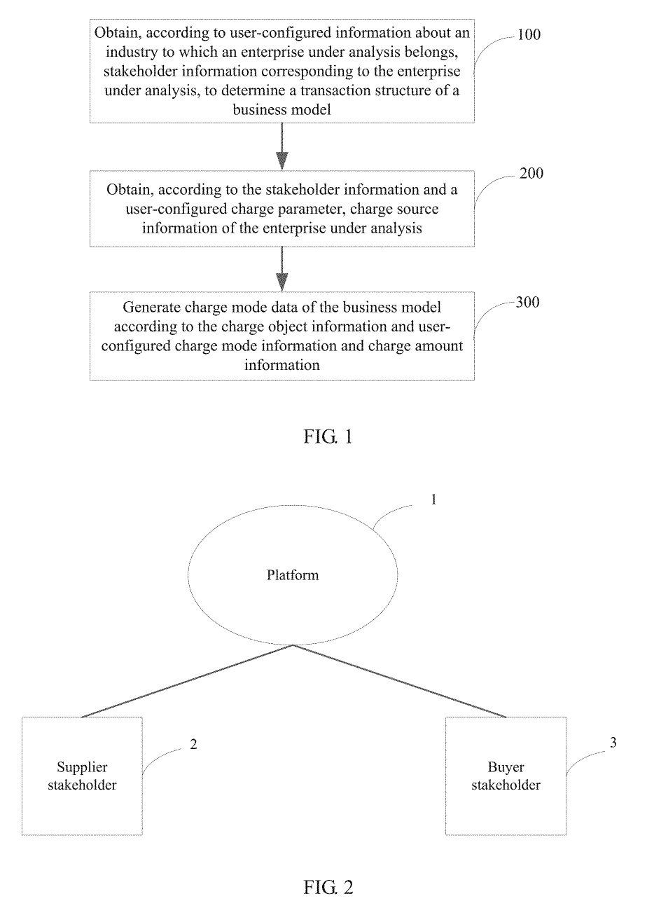

FIG. 1 shows a flowchart of a method for generating a business model according to an embodiment of the present invention. The following describes the method in detail.

In step 100, stakeholder information corresponding to an enterprise under analysis is obtained according to user-configured information about an industry to which the enterprise under analysis belongs, so that a transaction structure of a business model is determined.

The industry generally refers to a category of economic activity that produces a same type of product or has a same process or provides a same type of labor service, for example, a catering industry, a clothing industry, a machinery industry, a financial industry, or a mobile Internet Industry.

In the present invention, the stakeholder information includes at least supplier stakeholder information and buyer stakeholder information, where the supplier stakeholder information and the buyer stakeholder information corresponding to the supplier stakeholder information are obtained according to a positive feedback principle, and matching of supply and demand may be performed by using a platform provided by the enterprise under analysis, for example, a buyer and a seller of goods, a recruiting company and a job seeker, and the like.

In the present invention, the positive feedback principle means that an interdependent and mutual-strengthening relationship is formed between or within a supplier stakeholder and a buyer stakeholder. An example of positive feedback between stakeholders of a same type is: for instant messaging software QQ, if there are more QQ users and more communication is performed between users, QQ is more attractive to new users. An example of positive feedback between stakeholders of different types is: for example, in a home appliance chain store that obtains rental revenue, if there are more home appliance suppliers, and there are more types and brands of home appliances in the chain store, more consumers are attracted; conversely, if there are more consumers, the home appliance chain store can receive higher final consumptive power and naturally attract more home appliance suppliers.

In the present invention, the supplier stakeholder information and the buyer stakeholder information corresponding to the supplier stakeholder information may be generated by a back-end system through analysis according to the positive feedback principle, or may be directly entered by a user according to the positive feedback principle.

The transaction structure refers to a network topology formed by the enterprise under analysis and stakeholders and connections thereof. In the present invention, when the stakeholder information includes only the supplier stakeholder information and the buyer stakeholder information, the transaction structure of the business model may be expressed by using the structure in FIG. 2.

In a preferred embodiment of the present invention, the stakeholder information may further include third-party stakeholder information, where a third-party stakeholder is a stakeholder that accesses the platform for a business purpose but does not directly perform matching of supply and demand with a supplier stakeholder and a buyer stakeholder, for example, is an advertising promotion company that accesses the platform merely to publish advertisement information.

In the present invention, the supplier stakeholder information and the buyer stakeholder information corresponding to the enterprise under analysis may be obtained from a preset mapping relationship table of industry information and stakeholder information according to the industry information. The mapping relationship table of industry information and stakeholder information may be as follows, where A1, B1, and C1 indicate supplier stakeholders, A2, B2, and C2 indicate buyer stakeholders, and A3 indicates a third-party stakeholder.

TABLE 1

| Industry information | Stakeholder information |
|---|---|
| Industry A | (A1, A2, and A3) |
| Industry B | (B1 and B2) |
| Industry C | (C1 and C2) |

In the present invention, the user may enter the industry information by clicking a drop-down list box or selecting a check box on a display interface, or may enter the industry information by directly entering a text in a text box.

In step 200, charge source information of the enterprise under analysis is obtained according to the stakeholder information and a user-configured charge parameter.

In the present invention, the charge parameter is used as a basis for determining who will be charged by the enterprise under analysis. The charge parameter includes one or a combination of an attractiveness comparison parameter, a competitive environment comparison parameter, a demand elasticity comparison parameter, and a charge transaction cost comparison parameter.

The attractiveness comparison parameter is used to indicate, between a supplier stakeholder and a buyer stakeholder, who cares more about whom. This parameter may be obtained through calculation in the following manner, and further, how to establish a charge relationship and a payment relationship between the enterprise under analysis and the supplier stakeholder and between the enterprise under analysis and the buyer stakeholder is determined according to a calculation result.

In an implementation manner of the present invention, the care between the supplier stakeholder and the buyer stakeholder may be expressed in a form of a percentage, and a ratio of the two is equal to the attractiveness comparison parameter. When the attractiveness comparison parameter is greater than 1, the supplier stakeholder cares more about the buyer stakeholder, or otherwise, the buyer stakeholder cares more about the supplier stakeholder. For example, a1 indicates the supplier stakeholder's care about the buyer stakeholder, and a2 indicates the buyer stakeholder's care about the supplier stakeholder; when a1=20% and a2=80%, the attractiveness comparison parameter is a1÷a2=0.25; because the attractiveness comparison parameter is less than 1, it indicates that the buyer stakeholder cares more about the supplier stakeholder. In this case, because the buyer stakeholder cares more about the supplier stakeholder, it is feasible to establish a charge relationship between the enterprise under analysis and the buyer stakeholder. For example, an advertiser requires attention, and requires audience more than the audience require the advertiser; therefore, a profit model in which a television program charges the advertiser but does not charge the audience is rational.

It is understandable that the attractiveness comparison parameter may also be measured by using a difference between a1 and a2, which is not illustrated exhaustively herein.

The competitive environment comparison parameter is used to indicate which one of market environments of the supplier stakeholder and the buyer stakeholder has fiercer competition. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Generally, if the supplier stakeholder is in a competitive market, but the buyer stakeholder is in an imperfectly competitive market, because the buyer stakeholder has excessive profit, it is easier to establish a charge relationship between the enterprise under analysis and the buyer stakeholder.

The demand elasticity comparison parameter is used to indicate interdependence between the supplier stakeholder and the buyer stakeholder. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Generally, a stakeholder having higher demand elasticity is less charged or not charged.

The charge transaction cost comparison parameter is used to indicate which type of stakeholder is charged at lower cost. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Each profit model consumes certain transaction cost. There is no profit model in which revenue earned by charging a type of stakeholder is less than transaction cost paid for that.

In the embodiment of the present invention, when the charge parameter includes two or more of the attractiveness comparison parameter, the competitive environment comparison parameter, the demand elasticity comparison parameter, and the charge transaction cost comparison parameter, a charge relationship between the enterprise under analysis and a stakeholder is determined through calculation of a weight of each charge parameter.

In the present invention, the enterprise under analysis determines a charge object according to the charge source information, and charges the charge object.

In an embodiment of the present invention, when the stakeholder information includes the supplier stakeholder information and the buyer stakeholder information, the charge object is the supplier stakeholder or the buyer stakeholder.

In another embodiment of the present invention, when the stakeholder information includes the supplier stakeholder information, the buyer stakeholder information, and the third-party stakeholder information, the charge object is the third-party stakeholder, or a combination of the third-party stakeholder and the supplier stakeholder or the buyer stakeholder.

In step 300, charge mode data of the business model is generated according to the charge object information and user-configured charge mode information and charge amount information.

In the present invention, the charge mode may be one or a combination of: charge by time, charge by access qualification, charge by subscribed content, charge by usage, and charge by traffic.

In the present invention, the charge mode data is used to indicate a mode of charging the charge object by the enterprise under analysis and a charge amount.

In the method for generating a business model according to the embodiment of the present invention, stakeholder information corresponding to an enterprise under analysis is obtained according to information about an industry to which the enterprise under analysis belongs, so that a transaction structure of a business model is determined; further, charge source information of the enterprise under analysis is obtained according to the stakeholder information and a user-configured charge parameter; and charge mode data of the business model is generated according to the charge object information and user-configured charge mode information and charge amount information, so that a new business model is generated. In the new business model, a platform 1 provided by the enterprise under analysis provides a venue for a supplier stakeholder 2 and a buyer stakeholder 3 to perform matching of supply and demand, and both the supplier stakeholder 2 and the buyer stakeholder 3 can obtain a large amount of supply information and demand information through the platform 1, thereby solving a problem that information asymmetry causes an imbalance of interests between the two parties and hinders matching of supply and demand of the supplier and the buyer. Because more shopping choices are provided for the buyer stakeholder 3, and cost of the buyer in searching for shopping information is reduced, transaction cost is greatly reduced. In addition, supplier stakeholder information and buyer stakeholder information corresponding to the supplier stakeholder information are obtained according to a positive feedback principle, and an interdependent and mutual-strengthening relationship exists, that is, if there are more stakeholders of one type, more stakeholders of another type are attracted. Furthermore, stakeholders of a same type are strengthened by each other, that is, if there are more stakeholders of the same type, more stakeholders of the same type are attracted to join. In this way, positive feedback is implemented between the stakeholders of the same type and stakeholders of different types, and after the business model is started, the business model can hardly be broken by subsequent competitors.

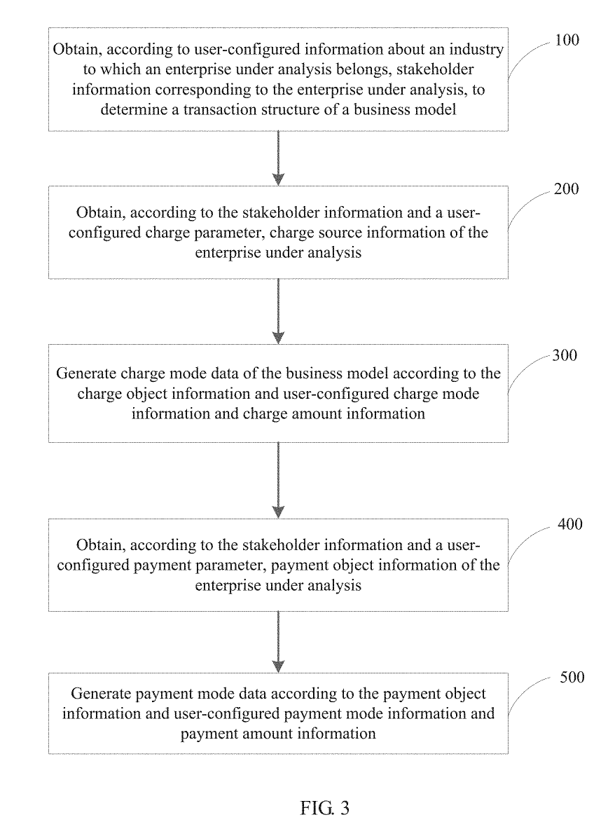

FIG. 3 is a flowchart of another method for generating a business model according to an embodiment of the present invention. A difference between this embodiment and the embodiment shown in FIG. 1 is as follows:

After step 100, steps 400 and 500 are further included.

In step 400, payment object information of the enterprise under analysis is obtained according to the stakeholder information and a user-configured payment parameter.

In the present invention, the payment parameter is used to determine to whom the enterprise under analysis makes payment, where the payment may be direct monetary payment, or may be some value-added services provided for the other party.

In an embodiment of the present invention, when the stakeholder information includes only supplier stakeholder information and buyer stakeholder information, the payment object information is the supplier stakeholder information or the buyer stakeholder information.

In another embodiment of the present invention, when the stakeholder information includes supplier stakeholder information, buyer stakeholder information, and third-party stakeholder information, the payment object information is the supplier stakeholder information or the buyer stakeholder information or a combination thereof.

In step 500, payment mode data is generated according to the payment object information and user-configured payment mode information and payment amount information.

In the present invention, the payment mode data indicates a payment mode and a payment amount between the enterprise under analysis and a payment object.

In the present invention, the charge source information and the payment object information constitute revenue and expenditure source information; the charge mode data and the payment mode data constitute pricing mode data.

In the embodiment of the present invention, the payment object information of the enterprise under analysis is obtained according to the stakeholder information and the user-configured payment parameter; and further, the payment mode data is generated according to the payment object information and the user-configured payment mode information and payment amount information. In this way, a payment relationship between the enterprise under analysis and a supplier stakeholder and/or a buyer stakeholder is established, and attractiveness of the enterprise under analysis to a stakeholder that has a payment relationship with the enterprise under analysis is enhanced.

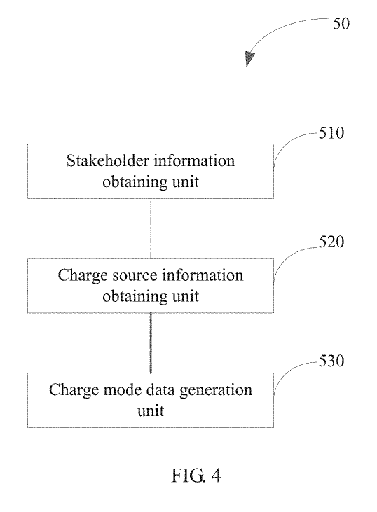

FIG. 4 shows a structure of an apparatus 50 for generating a business model according to an embodiment of the present invention. The apparatus includes a stakeholder information obtaining unit 510, a charge source information obtaining unit 520, and a charge mode data generation unit 530.

The stakeholder information obtaining unit 510 is configured to obtain, according to user-configured information about an industry to which an enterprise under analysis belongs, stakeholder information corresponding to the enterprise under analysis, to determine a transaction structure of a business model.

The industry generally refers to a category of economic activity that produces a same type of product or has a same process or provides a same type of labor service, for example, a catering industry, a clothing industry, a machinery industry, a financial industry, or a mobile Internet Industry.

In the present invention, the stakeholder information includes at least supplier stakeholder information and buyer stakeholder information, where the supplier stakeholder information and the buyer stakeholder information corresponding to the supplier stakeholder information are obtained according to a positive feedback principle, and matching of supply and demand may be performed by using a platform provided by the enterprise under analysis, for example, a buyer and a seller of goods, a recruiting company and a job seeker, and the like.

In the present invention, the positive feedback principle means that an interdependent and mutual-strengthening relationship is formed between or within a supplier stakeholder and a buyer stakeholder corresponding to the supplier stakeholder. An example of positive feedback between stakeholders of a same type is: for instant messaging software QQ, if there are more QQ users and more communication is performed between users, QQ is more attractive to new users. An example of positive feedback between stakeholders of different types is: for example, in a home appliance chain store that obtains rental revenue, if there are more home appliance suppliers, and there are more types and brands of home appliances in the chain store, more consumers are attracted; conversely, if there are more consumers, the home appliance chain store can receive higher final consumptive power and naturally attract more home appliance suppliers.

In the present invention, the supplier stakeholder information and the buyer stakeholder information may be generated by a back-end system through analysis according to the positive feedback principle, or may be directly entered by a user according to the positive feedback principle.

The transaction structure refers to a network topology formed by the enterprise under analysis and stakeholders and connections thereof. In the present invention, when the stakeholder information includes only the supplier stakeholder information and the buyer stakeholder information, the transaction structure of the business model may be expressed by using the structure in FIG. 2.

In a preferred embodiment of the present invention, the stakeholder information may further include third-party stakeholder information, where a third-party stakeholder is a stakeholder that accesses the platform for a business purpose but does not directly perform matching of supply and demand with a supplier stakeholder and a buyer stakeholder, for example, is an advertising promotion company that accesses the platform merely to publish advertisement information.

In the present invention, the supplier stakeholder information and the buyer stakeholder information corresponding to the enterprise under analysis may be obtained from a preset mapping relationship table of industry information and stakeholder information according to the industry information. The mapping relationship table of industry information and stakeholder information may be as follows, where A1, B1, and C1 indicate supplier stakeholders, A2, B2, and C2 indicate buyer stakeholders, and A3 indicates a third-party stakeholder.

TABLE 2

| Industry information | Stakeholder information |
|---|---|
| Industry A | (A1, A2, and A3) |
| Industry B | (B1 and B2) |
| Industry C | (C1 and C2) |

In the present invention, the user may enter the industry information by clicking a drop-down list box or selecting a check box on a display interface, or may enter the industry information by directly entering a text in a text box.

The charge source information obtaining unit 520 is configured to obtain, according to the stakeholder information and a user-configured charge parameter, charge source information of the enterprise under analysis.

In the present invention, the charge parameter is used as a basis for determining who will be charged by the enterprise under analysis. The charge parameter includes one or a combination of an attractiveness comparison parameter, a competitive environment comparison parameter, a demand elasticity comparison parameter, and a charge transaction cost comparison parameter.

The attractiveness comparison parameter is used to indicate, between a supplier stakeholder and a buyer stakeholder, who cares more about whom. This parameter may be obtained through calculation in the following manner, and further, how to establish a charge relationship and a payment relationship between the enterprise under analysis and the supplier stakeholder and between the enterprise under analysis and the buyer stakeholder is determined according to a calculation result.

In an implementation manner of the present invention, the care between the supplier stakeholder and the buyer stakeholder may be expressed in a form of a percentage, and a ratio of the two is equal to the attractiveness comparison parameter. When the attractiveness comparison parameter is greater than 1, the supplier stakeholder cares more about the buyer stakeholder, or otherwise, the buyer stakeholder cares more about the supplier stakeholder. For example, a1 indicates the supplier stakeholder's care about the buyer stakeholder, and a2 indicates the buyer stakeholder's care about the supplier stakeholder; when a1=20% and a2=80%, the attractiveness comparison parameter is a1+a2=0.25; because the attractiveness comparison parameter is less than 1, it indicates that the buyer stakeholder cares more about the supplier stakeholder. In this case, because the buyer stakeholder cares more about the supplier stakeholder, it is feasible to establish a charge relationship between the enterprise under analysis and the buyer stakeholder. For example, an advertiser requires attention, and requires audience more than the audience require the advertiser; therefore, a profit model in which a television program charges the advertiser but does not charge the audience is rational.

It is understandable that the attractiveness comparison parameter may also be measured by using a difference between a1 and a2, which is not illustrated exhaustively herein.

The competitive environment comparison parameter is used to indicate which one of market environments of the supplier stakeholder and the buyer stakeholder has fiercer competition. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Generally, if the supplier stakeholder is in a competitive market, but the buyer stakeholder is in an imperfectly competitive market, because the buyer stakeholder has excessive profit, it is easier to establish a charge relationship between the enterprise under analysis and the buyer stakeholder.

The demand elasticity comparison parameter is used to indicate interdependence between the supplier stakeholder and the buyer stakeholder. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Generally, a stakeholder having higher demand elasticity is less charged or not charged.

The charge transaction cost comparison parameter is used to indicate which type of stakeholder is charged at lower cost. This parameter may be calculated by using a method similar to that for calculating the attractiveness comparison parameter, and how to establish a charge relationship and a payment relationship and expressions thereof between the enterprise under analysis and the supplier stakeholder and between the enterprise under analysis and the buyer stakeholder is determined, which is not further described herein. Each profit model consumes certain transaction cost. There is no profit model in which revenue earned by charging a type of stakeholder is less than transaction cost paid for that.

In the embodiment of the present invention, when the charge parameter includes two or more of the attractiveness comparison parameter, the competitive environment comparison parameter, the demand elasticity comparison parameter, and the charge transaction cost comparison parameter, a charge relationship between the enterprise under analysis and a stakeholder is determined through calculation of a weight of each charge parameter.

In the present invention, the enterprise under analysis determines a charge object according to the charge source information, and charges the charge object.

In an embodiment of the present invention, when the stakeholder information includes the supplier stakeholder information and the buyer stakeholder information, the charge object is the supplier stakeholder or the buyer stakeholder.

In another embodiment of the present invention, when the stakeholder information includes the supplier stakeholder information, the buyer stakeholder information, and the third-party stakeholder information, the charge object is the third-party stakeholder, or a combination of the third-party stakeholder and the supplier stakeholder or the buyer stakeholder.

The charge mode data generation unit 530 is configured to generate charge mode data of the business model according to the charge object information and user-configured charge mode information and charge amount information.

In the present invention, the charge mode may be one or a combination of: charge by time, charge by access qualification, charge by subscribed content, charge by usage, and charge by traffic.

In the present invention, the charge mode data is used to indicate a mode of charging the charge object by the enterprise under analysis and a charge amount.

In the apparatus for generating a business model according to the embodiment of the present invention, stakeholder information corresponding to an enterprise under analysis is obtained according to information about an industry to which the enterprise under analysis belongs, so that a transaction structure of a business model is determined; further, charge source information of the enterprise under analysis is obtained according to the stakeholder information and a user-configured charge parameter; and charge mode data of the business model is generated according to the charge object information and user-configured charge mode information and charge amount information, so that a new business model is generated. In the new business model, a platform 1 provided by the enterprise under analysis provides a venue for a supplier stakeholder 2 and a buyer stakeholder 3 to perform matching of supply and demand, and both the supplier stakeholder 2 and the buyer stakeholder 3 can obtain a large amount of supply information and demand information through the platform 1, thereby solving a problem that information asymmetry causes an imbalance of interests between the two parties and hinders matching of supply and demand of the supplier and the buyer. Because more shopping choices are provided for the buyer stakeholder 3, and cost of the buyer in searching for shopping information is reduced, transaction cost is greatly reduced. In addition, supplier stakeholder information and buyer stakeholder information corresponding to the supplier stakeholder information are obtained according to a positive feedback principle, and an interdependent and mutual-strengthening relationship exists, that is, if there are more stakeholders of one type, more stakeholders of another type are attracted. Furthermore, stakeholders of a same type are strengthened by each other, that is, if there are more stakeholders of the same type, more stakeholders of the same type are attracted to join. In this way, positive feedback is implemented between the stakeholders of the same type and stakeholders of different types, and after the business model is started, the business model can hardly be broken by subsequent competitors.

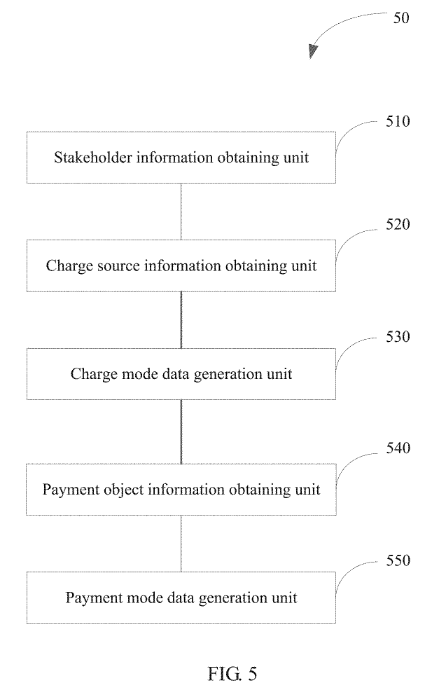

FIG. 5 shows a structure of another apparatus for generating a business model according to an embodiment of the present invention. Different from the embodiment shown in FIG. 4, the apparatus further includes a payment object information obtaining unit 540 and a payment mode data generation unit 550.

The payment object information obtaining unit 540 is configured to obtain, according to the stakeholder information and a user-configured payment parameter, payment object information of the enterprise under analysis.

In the present invention, the payment parameter is used to determine to whom the enterprise under analysis makes payment, where the payment may be direct monetary payment, or may be some value-added services provided for the other party.

In an embodiment of the present invention, when the stakeholder information includes only supplier stakeholder information and buyer stakeholder information, the payment object information is the supplier stakeholder information or the buyer stakeholder information.

In another embodiment of the present invention, when the stakeholder information includes supplier stakeholder information, buyer stakeholder information, and third-party stakeholder information, the payment object information is the supplier stakeholder information or the buyer stakeholder information or a combination thereof.

The payment mode data generation unit 550 is configured to generate payment mode data according to the payment object information and user-configured payment mode information and payment amount information.

In the present invention, the payment mode data indicates a payment mode and a payment amount between the enterprise under analysis and a payment object.

In the present invention, the charge source information and the payment object information constitute revenue and expenditure source information; the charge mode data and the payment mode data constitute pricing mode data.

In the embodiment of the present invention, the payment object information of the enterprise under analysis is obtained according to the stakeholder information and the user-configured payment parameter; and further, the payment mode data is generated according to the payment object information and the user-configured payment mode information and payment amount information. In this way, a payment relationship between the enterprise under analysis and a supplier stakeholder and/or a buyer stakeholder is established, and attractiveness of the enterprise under analysis to a stakeholder that has a payment relationship with the enterprise under analysis is enhanced.

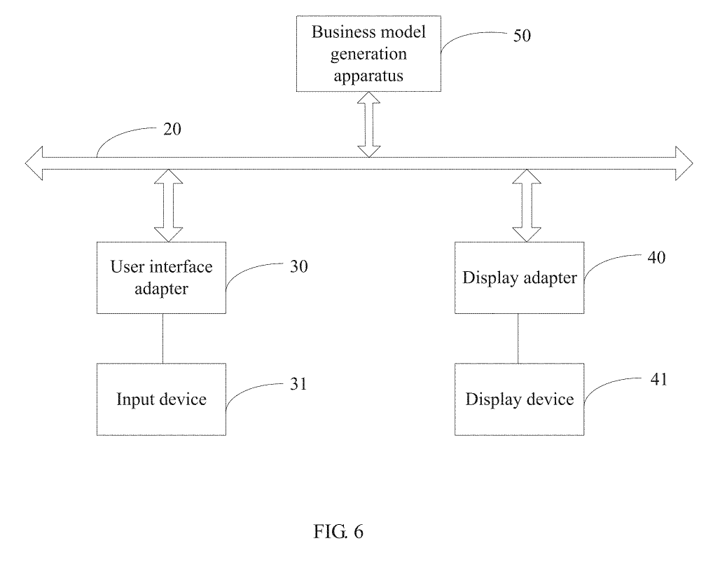

FIG. 6 shows a structure of a system for generating a business model according to an embodiment of the present invention. The system includes:

a bus 20, configured to transmit signaling and data;

a user interface adapter 30, configured to connect an input device 31 to the bus 20, and receive information about an industry to which an enterprise under analysis belongs, a charge parameter, charge mode information, and charge amount information that are configured by a user;

a display adapter 40, configured to connect a display device 41 to the bus 20, and display the information about the industry to which the enterprise under analysis belongs, the charge parameter, the charge mode information, the charge amount information, obtained charge source information, and generated charge mode data; and

a business model generation apparatus 50, configured to receive the information about the industry to which the enterprise under analysis belongs, the charge parameter, the charge mode information, and the charge amount information that are transmitted by the user interface adapter 30 through the bus 20, and obtain, according to the information about the industry to which the enterprise under analysis belongs, stakeholder information corresponding to the enterprise under analysis, to determine a transaction structure of a business model; obtain, according to the stakeholder information and the user-configured charge parameter, the charge source information of the enterprise under analysis; and generate the charge mode data of the business model according to the charge object information and the user-configured charge mode information and charge amount information; where

the stakeholder information includes at least supplier stakeholder information and buyer stakeholder information, where the supplier stakeholder information and the buyer stakeholder information corresponding to the supplier stakeholder information are obtained according to a positive feedback principle, and matching of supply and demand may be performed by using a platform provided by the enterprise under analysis.

The structure of the business model generation apparatus in the present invention is not further described herein. For details, reference may be made to the detailed description of the embodiment shown in FIG. 4 or 5.

In the system for generating a business model according to the embodiment of the present invention, stakeholder information corresponding to an enterprise under analysis is obtained according to information about an industry to which the enterprise under analysis belongs, so that a transaction structure of a business model is determined; further, charge source information of the enterprise under analysis is obtained according to the stakeholder information and a user-configured charge parameter; and charge mode data of the business model is generated according to the charge object information and user-configured charge mode information and charge amount information, so that a new business model is generated. In the new business model, a platform 1 provided by the enterprise under analysis provides a venue for a supplier stakeholder 2 and a buyer stakeholder 3 to perform matching of supply and demand, and both the supplier stakeholder 2 and the buyer stakeholder 3 can obtain a large amount of supply information and demand information through the platform 1, thereby solving a problem that information asymmetry causes an imbalance of interests between the two parties and hinders matching of supply and demand of the supplier and the buyer. Because more shopping choices are provided for the buyer stakeholder 3, and cost of the buyer in searching for shopping information is reduced, transaction cost is greatly reduced. In addition, supplier stakeholder information and buyer stakeholder information corresponding to the supplier stakeholder information are obtained according to a positive feedback principle, and an interdependent and mutual-strengthening relationship exists, that is, if there are more stakeholders of one type, more stakeholders of another type are attracted. Furthermore, stakeholders of a same type are strengthened by each other, that is, if there are more stakeholders of the same type, more stakeholders of the same type are attracted to join. In this way, positive feedback is implemented between the stakeholders of the same type and stakeholders of different types, and after the business model is started, the business model can hardly be broken by subsequent competitors.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

Only exemplary embodiments of the present invention are described above. However, the scope of the present invention is not limited thereto. All modifications, equivalent replacements, and improvements made without departing from the spirit and principle of the present invention shall fall within the protection scope of the present invention.

A person of ordinary skill in the art understands that each aspect of the present invention or a possible implementation manner of each aspect may be specifically implemented as a system, a method, or a computer program product. Therefore, each aspect of the present invention or the possible implementation manner of each aspect may use a form of hardware only embodiments, software only embodiments (including firmware, resident software, and the like), or embodiments with a combination of software and hardware, which are collectively called “a circuit”. “a module”, or “a system”. In addition, each aspect of the present invention or the possible implementation manner of each aspect may use a form of a computer program product, where the computer program product refers to computer readable program code stored in a computer readable medium.

The computer readable medium may be a computer readable signal medium or a computer readable storage medium. A computer readable storage medium includes but is not limited to an electronic, magnetic, optical, electromagnetic, infrared, or semiconductor system, device, or apparatus, or any suitable combination of the foregoing, for example, a random access memory (RAM), a read-only memory (ROM), an erasable programmable read-only memory (EPROM or flash memory), an optical fiber, or a portable compact disc read-only memory (CD-ROM).

A processor in a computer reads the computer readable program code stored in the computer readable medium, so that the processor can execute each step in the flowchart or function actions specified in a combination of steps, and generate an apparatus for implementing each block in a block diagram or function actions specified in a combination of blocks.

The computer readable program code may be completely executed on a computer of a user, or partially executed on a computer of a user, or as an independent software package, partially executed on a computer of a user and partially executed on a remote computer, or completely executed on a remote computer or a server. It should also be noted that in some alternative implementation solutions, each step in the flowchart or the function indicated by each block in the block diagram may occur not in accordance with the sequence indicated in the drawing. For example, two steps or two blocks that are connected and shown depending on involved functions may be actually executed approximately at the same time, or sometimes these blocks may be executed in a reverse sequence.

It is apparent to a person skilled in the art that various modifications and variations can be made to the present invention without departing from the scope or spirit of the present invention. The present invention is intended to cover these modifications and variations provided that they fall within the scope of protection defined by the following claims and their equivalent technologies.

What is claimed is:

1. A method of generating a business model, comprising:
obtaining stakeholder information corresponding to the enterprise under analysis to determine transaction structure of business model, according to user-configured information about the industry to which an enterprise under analysis belongs;
obtaining charge source information of the enterprise under analysis according to the stakeholder information and a user-configured charge parameter; and
generating charge mode data of the business model according to the charge object information, user-configured charge mode information and charge amount information; wherein
the stakeholder information comprises at least supplier stakeholder information and buyer stakeholder information corresponding to the supplier stakeholder information, the supplier stakeholder information and the buyer stakeholder information corresponding to the supplier stakeholder information are obtained according to a positive feedback principle, and matching of supply and demand can be performed by using a platform provided by the enterprise under analysis.

2. The method of claim 1, wherein the positive feedback principle means that an interdependent and mutual-strengthening relationship is formed between or within a supplier stakeholder and a buyer stakeholder.

3. The method of 1, wherein the charge parameter comprises one or a combination of an attractiveness comparison parameter, a competitive environment comparison parameter, a demand elasticity comparison parameter, and a charge transaction cost comparison parameter.

4. The method of claim 1, wherein the charge mode comprises one or a combination of: charge by time, charge by access qualification, charge by subscribed content, charge by usage, and charge by traffic.

5. The method of 1, wherein the stakeholder information further comprises third-party stakeholder information, wherein a third-party stakeholder is a stakeholder that accesses the platform for a business purpose but does not directly perform matching of supply and demand with a supplier stakeholder and a buyer stakeholder.

6. The method of 1, wherein after the step of obtaining stakeholder information corresponding to the enterprise under analysis according to user-configured information about an industry to which an enterprise under analysis belongs, the method further comprises:
obtaining payment object information of the enterprise under analysis according to the stakeholder information and a user-configured payment parameter; and
generating payment mode data according to the payment object information and user-configured payment mode information and payment amount information.

7. An apparatus for generating a business model, comprising:
a stakeholder information obtaining unit, configured to obtain stakeholder information corresponding to the enterprise under analysis to determine a transaction structure of a business model, according to user-configured information about an industry to which an enterprise under analysis belongs;
a charge source information obtaining unit, configured to obtaining charge source information of the enterprise under analysis according to the stakeholder information and a user-configured charge parameter; and
a charge mode data generation unit, configured to generate charge mode data of the business model according to the charge object information and user-configured charge mode information and charge amount information; wherein
the stakeholder information comprises at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

8. The apparatus of claim 7, wherein the positive feedback principle means that an interdependent and mutual-strengthening relationship is formed between or within a supplier stakeholder and a buyer stakeholder.

9. The apparatus of claim 7, wherein the charge parameter comprises one or a combination of an attractiveness comparison parameter, a competitive environment comparison parameter, a demand elasticity comparison parameter, and a charge transaction cost comparison parameter.

10. The apparatus of 7, wherein the charge mode comprises one or a combination of: charge by time, charge by access qualification, charge by subscribed content, charge by usage, and charge by traffic.

11. The apparatus of 7, wherein the stakeholder information further comprises a third-party stakeholder information, wherein the third-party stakeholder is a stakeholder that accesses the platform for a business purpose but does not directly perform matching of supply and demand with a supplier stakeholder and a buyer stakeholder.

12. The apparatus of claim 7, further comprising:
a payment object information obtaining unit, configured to obtain payment object information of the enterprise under analysis according to the stakeholder information and a user-configured payment parameter; and
a payment mode data generation unit, configured to generate payment mode data according to the payment object information and user-configured payment mode information and payment amount information.

13. A system for generating a business model, comprises:
a bus, configured to transmit signaling and data;
a user interface adapter, configured to connect an input device to the bus, and receive information about an industry to which an enterprise under analysis belongs, a charge parameter, charge mode information, and charge amount information that are configured by a user;
a display adapter, configured to connect a display device to the bus, and display the information about the industry to which the enterprise under analysis belongs, the charge parameter, the charge mode information, the charge amount information, obtained charge source information, and generated charge mode data; and
a business model generation apparatus, configured to receive the information about the industry to which the enterprise under analysis belongs, the charge parameter, the charge mode information, and the charge amount information that are transmitted by the user interface adapter through the bus, and obtain stakeholder information corresponding to the enterprise under analysis according to the information about the industry to which the enterprise under analysis belongs, to determine a transaction structure of a business model; obtain the charge source information of the enterprise under analysis according to the stakeholder information and the user-configured charge parameter; and generate the charge mode data of the business model according to the charge object information and the user-configured charge mode information and charge amount information; wherein
the stakeholder information comprises at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

14. The system for generating a business model of claim 13, wherein the business model generation apparatus is configured to:
obtain stakeholder information corresponding to the enterprise under analysis according to user-configured information about an industry to which an enterprise under analysis belongs, to determine a transaction structure of a business model;
obtain charge source information of the enterprise under analysis according to the stakeholder information and a user-configured charge parameter; and
generate charge mode data of the business model according to the charge object information and user-configured charge mode information and charge amount information.

15. The system of claim 13, wherein the positive feedback principle means that an interdependent and mutual-strengthening relationship is formed between or within a supplier stakeholder and a buyer stakeholder.

16. The system of claim 13, wherein the charge parameter comprises one or a combination of an attractiveness comparison parameter, a competitive environment comparison parameter, a demand elasticity comparison parameter, and a charge transaction cost comparison parameter.

17. The system of claim 13, wherein the charge mode comprises one or a combination of: charge by time, charge by access qualification, charge by subscribed content, charge by usage, and charge by traffic.

18. The system of claim 14, wherein the apparatus further comprises:
a payment object information obtaining unit, configured to obtain payment object information of the enterprise under analysis according to the stakeholder information and a user-configured payment parameter; and
a payment mode data generation unit, configured to generate payment mode data according to the payment object information and user-configured payment mode information and payment amount information.

19. A computer readable storage medium, wherein the computer readable storage medium stores a computer program instruction executable by a computer, and when the computer executes the computer program instruction, the computer executes a method for generating a business model, wherein the method for generating a business model comprises:
obtaining stakeholder information corresponding to the enterprise under analysis according to user-configured information about an industry to which an enterprise under analysis belongs, to determine a transaction structure of a business model;
obtaining charge source information of the enterprise under analysis according to the stakeholder information and a user-configured charge parameter; and
generating charge mode data of the business model according to the charge object information and user-configured charge mode information and charge amount information; wherein
the stakeholder information comprises at least supplier stakeholder information and buyer stakeholder information corresponding to the supplier stakeholder information, wherein the supplier stakeholder information and the buyer stakeholder information corresponding to the supplier stakeholder information are obtained according to a positive feedback principle, and matching of supply and demand can be performed by using a platform provided by the enterprise under analysis.

20. The computer readable storage medium of claim 19, wherein after obtaining stakeholder information corresponding to the enterprise under analysis according to user-configured information about an industry to which an enterprise under analysis belongs, the method further comprises:
obtaining payment object information of the enterprise under analysis, according to the stakeholder information and a user-configured payment parameter; and
generating payment mode data according to the payment object information and user-configured payment mode information and payment amount information.
